(19) United States
(12) Patent Application Publication
(10) Pub. No.: US 2020/0272284 A1
(43) Pub. Date: Aug. 27, 2020

(54) GRAFTING HIERARCHICAL TREES IN A GRAPHICAL USER INTERFACE (GUI)

(71) Applicant: Dell Products, L.P., Round Rock, TX (US)

(72) Inventor: Reginald H. Stumpe, JR., Round Rock, TX (US)

(73) Assignee: Dell Products, L.P., Round Rock, TX (US)

(21) Appl. No.: 16/287,763

(22) Filed: Feb. 27, 2019

(51) Int. Cl. G06F 3/0482; G06F 16/22; G06F 16/25; G06F 16/245; G06F 7/08; G06F 3/0484

(52) U.S. Cl. CPC G06F 3/0482; G06F 16/2246; G06F 3/04847; G06F 16/245; G06F 7/08; G06F 16/252

(57) ABSTRACT

Embodiments of systems and methods for grafting hierarchical trees in a Graphical User Interface (GUI) are described. In an embodiment, an Information Handling System (IHS) may include a processor; and a memory coupled to the processor, the memory having program instructions stored thereon that, upon execution by the processor, cause the IHS to: receive, from a user, selection of a first node of a hierarchical tree displayed via a GUI, where the first node enables the user to navigate data items with a first query; receive, from the user, selection of a first sub-tree; and graft the first sub-tree onto the first node, wherein the first grafted sub-tree enables the user to navigate a first subset of data items with a second query, and where the first subset of data items results from application of the first query to the data items.

### FIELD

The present disclosure generally relates to Information Handling Systems (IHSs), and, more particularly, to systems and methods for grafting hierarchical trees in a Graphical User Interface (GUI).

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

In many IHS applications, a hierarchical tree enables a user to navigate data displayed via a Graphical User Interface (GUI). As the inventors hereof have recognized, however, the structure of a conventional hierarchical tree is not changeable by the user.

### SUMMARY

Embodiments of systems and methods for grafting hierarchical trees in a Graphical User Interface (GUI) are described. In an illustrative, non-limiting embodiment, an Information Handling System (IHS) may include a processor; and a memory coupled to the processor, the memory having program instructions stored thereon that, upon execution by the processor, cause the IHS to: receive, from a user, selection of a first node of a hierarchical tree displayed via a GUI, where the first node enables the user to navigate data items with a first query; receive, from the user, selection of a first sub-tree; and graft the first sub-tree onto the first node, where the first grafted sub-tree enables the user to navigate a first subset of data items with a second query, and where the first subset of data items results from application of the first query to the data items.

For example, the hierarchical tree may be displayed via a web browser or client application in a navigation portion of the GUI. Also, the data items may be displayed via the web browser or client application in a table portion of the GUI.

The program instructions, upon execution by the processor, may further cause the IHS to filter or order the data items in the table portion of the GUI differently in response to selection of a different node of the hierarchical tree in the navigation portion of the GUI. Additionally, or alternatively, the program instructions, upon execution by the processor, may further cause the IHS to filter or order the first subset of data items in the table portion of the GUI differently in response to selection of a different node of the grafted sub-tree in the navigation portion of the GUI.

The program instructions, upon execution by the processor, may cause the IHS to display a grafting tool menu via the GUI, where the grafting tool menu enables the user to select the first sub-tree among a plurality of sub-trees. In some cases, at least one of the plurality of subtrees comprises two or more different hierarchical levels. Additionally, or alternatively, at least one of the plurality of subtrees enables the first subset of data items to be sorted by physical location of physical devices corresponding to the data items. Additionally, or alternatively, at least one of the plurality of subtrees sorts the first subset of data items by type of physical device corresponding to the data items. Additionally, or alternatively, at least one of the plurality of subtrees sorts the first subset of data items by warranty status corresponding to the data items.

The program instructions, upon execution by the processor, may further cause the IHS to: receive, from the user, selection of a second node of the first grafted sub-tree; receive, from the user, selection of a second sub-tree; and graft the second sub-tree onto the second node of the first grafted subtree, where the second grafted sub-tree enables the user to navigate a second subset of data items with a third query, and where the second subset of data items results from application of the second query to the first subset of data items.

The program instructions, upon execution by the processor, may further cause the IHS to receive, from the user, selection of the second node of the first grafted sub-tree; receive, from the user, selection of a third sub-tree; and replace the second grafted sub-tree with the third sub-tree, where the third sub-tree enables the user to navigate the second subset of data items with a fourth query.

In another illustrative, non-limiting embodiment, a method may include receiving, from a user, selection of a first node of a hierarchical tree displayed by an IHS via a GUI, where the first node enables the user to navigate data items; receiving, from the user, selection of a first sub-tree; and grafting the first sub-tree onto the first node, where the first grafted sub-tree enables the user to navigate a first subset of data items with a second query, and where the first subset of data items results from application of a first query to the data items.

The hierarchical tree may be displayed via a web browser or client application executed by the IHS in a navigation portion of the GUI, and the data items may be displayed via the web browser or client application executed by the IHS in a table portion of the GUI.

The method may also include filtering or ordering the data items in the table portion of the GUI differently in response to selection of a different node of the hierarchical tree or the grafted sub-tree in the navigation portion of the GUI. The method may also include displaying a grafting tool menu via the GUI, where the grafting tool menu may enable the user to select the first sub-tree among a plurality of sub-trees.

In some cases, at least one of the plurality of subtrees may enable the first subset of data items to be sorted by physical location, type of physical device, or warranty status of a physical device corresponding to the data item. The method may also include receiving, from the user, selection of a second node of the first grafted sub-tree; receiving, from the user, selection of a second sub-tree; and grafting the second sub-tree onto the second node of the first grafted subtree, where the second grafted sub-tree enables the user to navigate a second subset of data items with a third query, and where the second subset of data items results from application of the second query to the first subset of data items.

In yet another illustrative, non-limiting embodiment, a hardware memory of an IHS may have program instructions stored thereon that, upon execution by a processor, cause the IHS to: receive, from a user, selection of a first node of a hierarchical tree displayed by the IHS via a GUI, where the first node enables the user to navigate data with a first query; receive, from the user, selection of a first sub-tree; graft the first sub-tree onto the first node, where the first grafted sub-tree enables the user to navigate a first subset of data items, and the first subset of data items results from application of the first query to the data items; receive, from the user, selection of a second node of the first sub-tree; receive, from the user, selection of a second sub-tree; and graft the second sub-tree onto the second node, where the second grafted sub-tree enables the user to navigate the first subset of data items.

The hardware memory of claim 19, where the program instructions upon execution by a processor, cause the IHS to: receive, from the user, selection of the first node of the hierarchical tree; receive, from the user, selection of a third sub-tree; and replace the first grafted sub-tree with the third sub-tree, where the third sub-tree enables the user to navigate the data items with a third query.

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIGS. 1A-E illustrate various tree grafting techniques, according to some embodiments.

FIGS. 2A-F illustrate an example of a method for grafting hierarchical trees in a

Graphical User Interface (GUI), according to some embodiments.

FIG. 3 illustrates an example of an Information Handling System (IHS) configured to implement methods described herein, according to some embodiments.

### DETAILED DESCRIPTION

Systems and methods for grafting hierarchical trees in a Graphical User Interface (GUI) are described. The term “hierarchical tree” (or “tree”), as used herein, refers to a structure that has a root value and subtrees of children with a parent node, represented as a set of linked nodes. In various embodiments, these systems and methods may employ hierarchical trees that enable users to visually navigate (e.g., query, sort, order, select, etc.) objects or data items stored in a database, or the like, in virtually any Information Handling System (IHS) application.

Particularly, techniques discussed herein enable “grafting” a sub-tree in and/or out of any selected node of a hierarchical tree in a GUI. Multiple grafts may be made. Each graft may start with the data for the node to which it is grafted—that is, each graft may handle only a subset of the original data that results from a previous query. This allows users to select and drill down to the information they want to see.

Whereas conventional GUI tools perform only basic sorting (e.g., sort by price, sort by relevance) and/or filter operations (e.g., show only data items with property or attribute “x”) on data items, those GUI tools do not perform sub-queries on a current set of data items. In contrast, rather than simply sorting or filtering data, systems and methods described herein provide a flexible, dynamic, and interactive mechanism to execute sub-queries on data.

As such, these systems and methods enable users to select tree display structures in real-time, via a GUI, without being constrained by otherwise fixed or hard-coded structures presented to them; which increases navigation possibilities and provides unique, dynamic, and interactive ways to work with any data, in various IHS applications. A benefit of grafting is that it lets customers view data structurally in a dynamic way, as they choose, in addition to being usable for filtering.

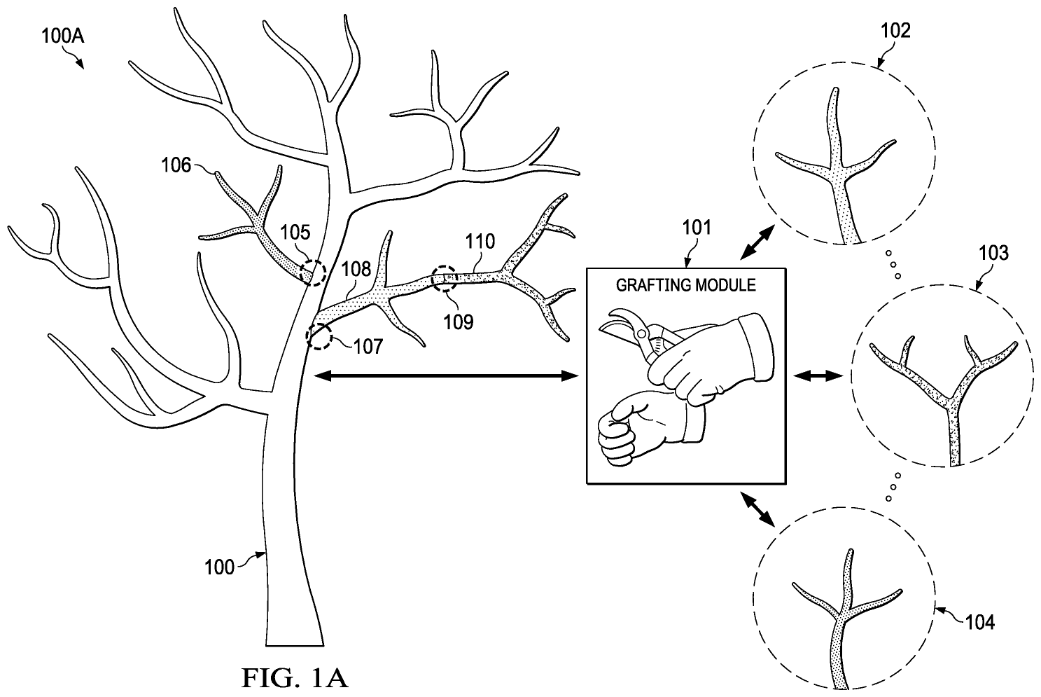

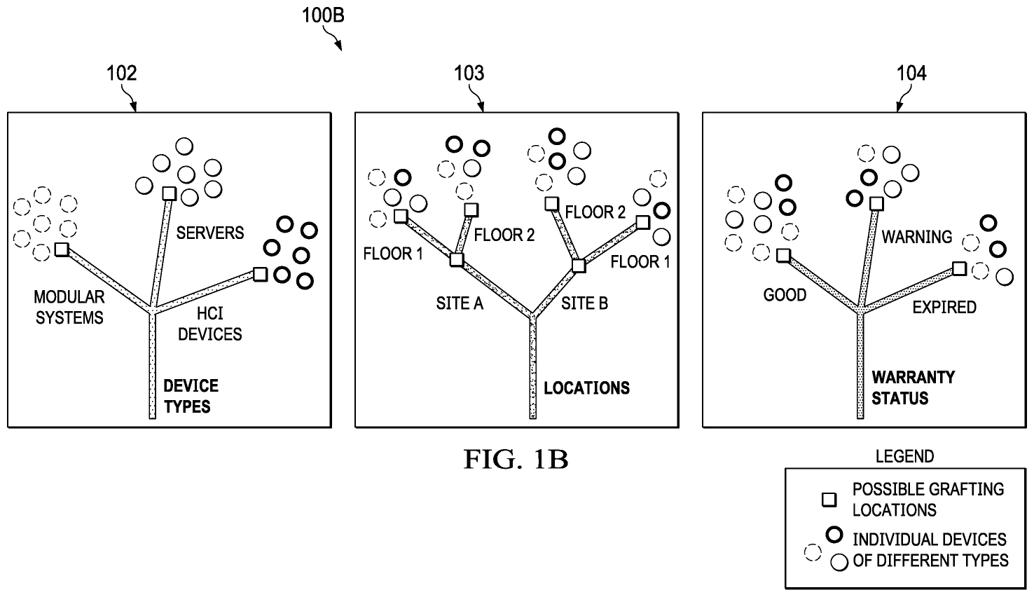

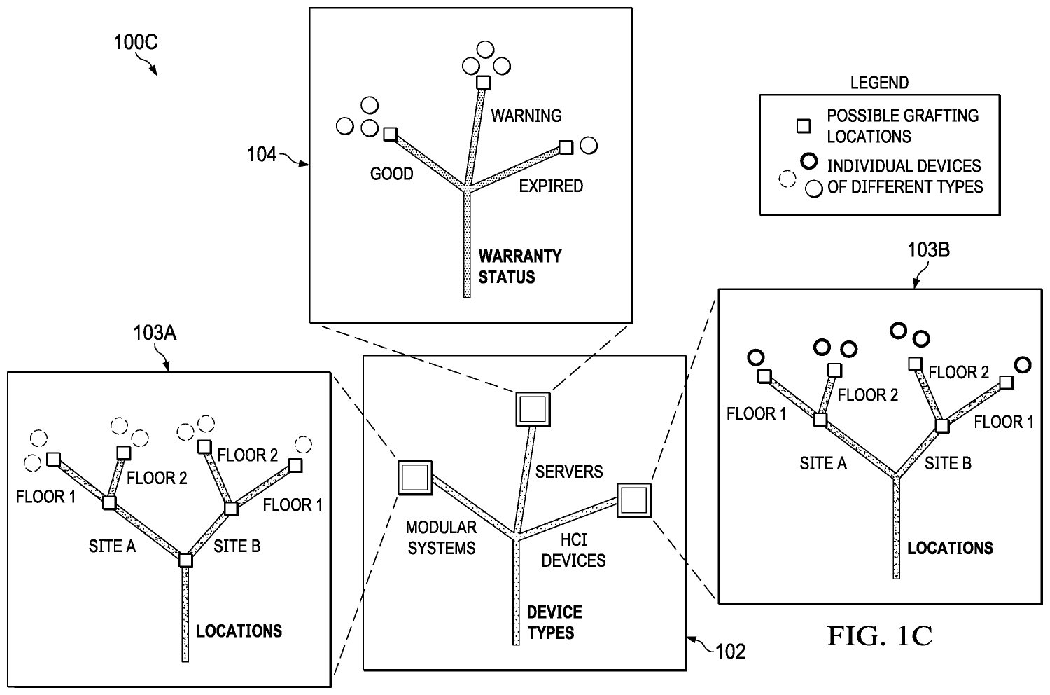

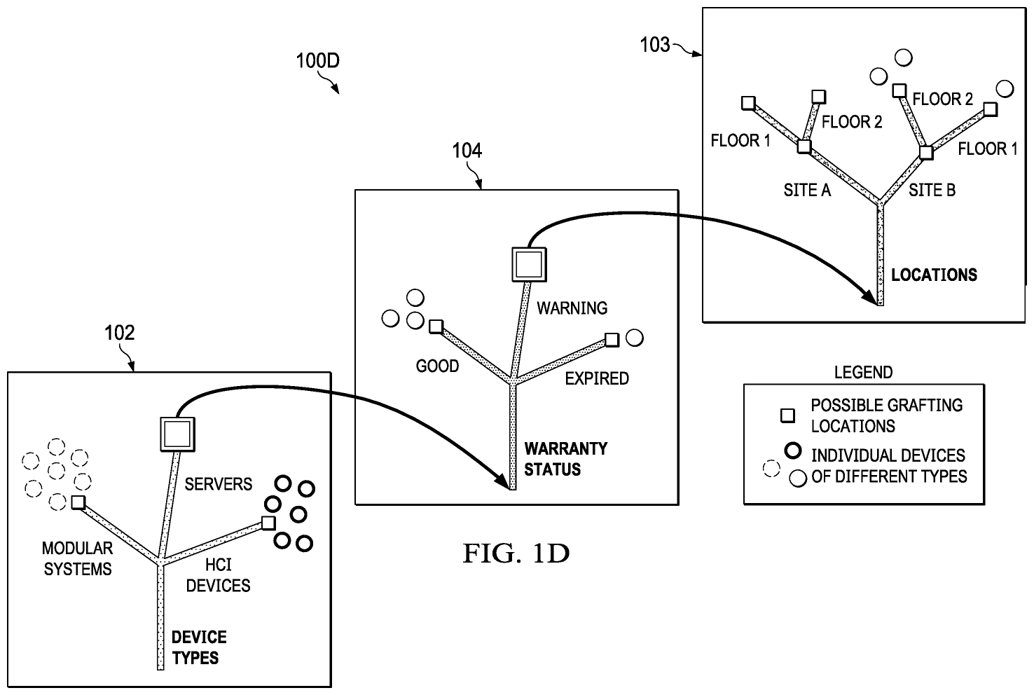

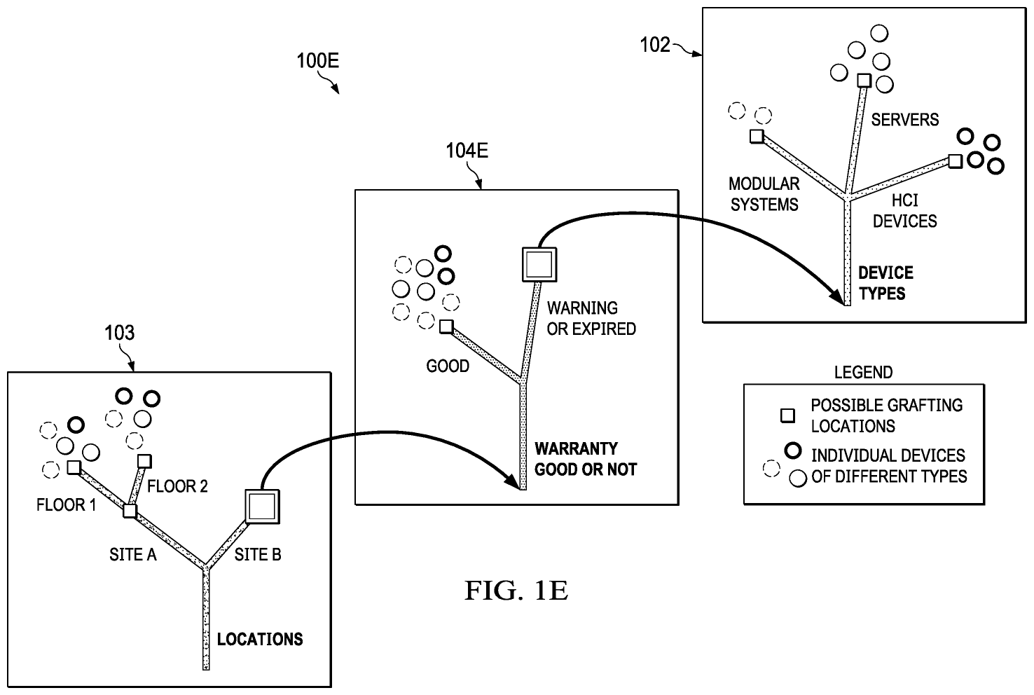

FIG. 1A provides an explanation of tree grafting technique 100A. For ease of understanding, hierarchical tree 100 is depicted as a natural tree with a plurality of branches. Grafting module 101 is responsible for maintaining sub-tree structures 102-104, and for grafting selected ones of sub-trees 102-104 in and/or out of selected nodes of hierarchical tree 100 (or nodes of other sub-trees).

As shown in this example, instance 106 of sub-tree 104 is grafted onto node 105 of hierarchical tree 100. Instance 108 of sub-tree 102 is grafted onto node 107 of hierarchical tree 100. And instance 110 of sub-tree 103 is grafted onto node 109 of instance 108 of sub-tree 102.

In some cases, grafting module 101 may be used to graft a sub-tree onto a node. Additionally, or alternatively, grafting module 101 may be used to remove a sub-tree from a node. Additionally, or alternatively, grafting module 101 may be used to replace a grafted sub-tree at a node, or between two selected nodes.

FIG. 1B illustrates implementation examples 100B of sub-trees 102-104. Particularly, in examples 100B, sub-tree 102 is a “device type” sub-tree with branches for “modular systems,” “servers,” and “HCI devices.” The end of each branch includes a possible grafting location.

Sub-tree 103 is a “locations” sub-tree with branches for “site A” and “site B” objects or data items. Each of these branches then breaks out into “floor 1” and “floor 2” branches with their respective objects or data items. Meanwhile, sub-tree 104 is a “warranty status” sub-tree with branches for “good,” “warning,” and “expired” objects or data items.

FIG. 1C illustrates sub-tree 102 with possible grafts 100C. Particularly, sub-tree 104 may be grafted onto the “servers” node of sub-tree 102. As a result, branches of sub-tree 104 show or query all server objects or data items, hierarchically by warranty status.

In addition, a first location sub-tree 103A may be grafted onto the “modular systems” node of sub-tree 102. As a result, branches of sub-tree 103A show or query all modular systems objects or data items, hierarchically by location. Finally, a second location sub-tree 103B may be grafted onto the “HCI devices” node of sub-tree 102. As a result, branches of sub-tree 103B show all HCI devices objects or data items, hierarchically by location.

FIG. 1D shows the effect of multiple, sequential grafts 100D. In this case, sub-tree 102 has sub-tree 104 grafted onto its “servers” node. Sub-tree 103 is grafted onto the “warning” node of sub-tree 104. As a result, branches of sub-tree 103 show or query all objects or data items that are servers and have a warning warranty status, hierarchically by location.

FIG. 1E shows the effect of multiple, sequential grafts 100E. In this case, sub-tree 103 has a user-defined warranty status sub-tree 104E grafted onto its “site B” node. User-defined sub-tree 104E includes two branches, “good” and “warning or expired,” and therefore it provides intermediate query results: all devices, hierarchically by “warranty good or not” at site B, which is a non-terminal node of sub-tree 103 (any floor). Note, however, that it would be easy for the end-user to move this same graft to either floor 1 or floor 2 of site B, or to site A or one of its floors.

Then, sub-tree 102 is grafted onto the “warning or expired” branch of user-defined sub-tree 104E. As a result, branches of sub-tree 102 show or query all devices, hierarchically by device type, with a warning or expired warranty, at site B (any floor).

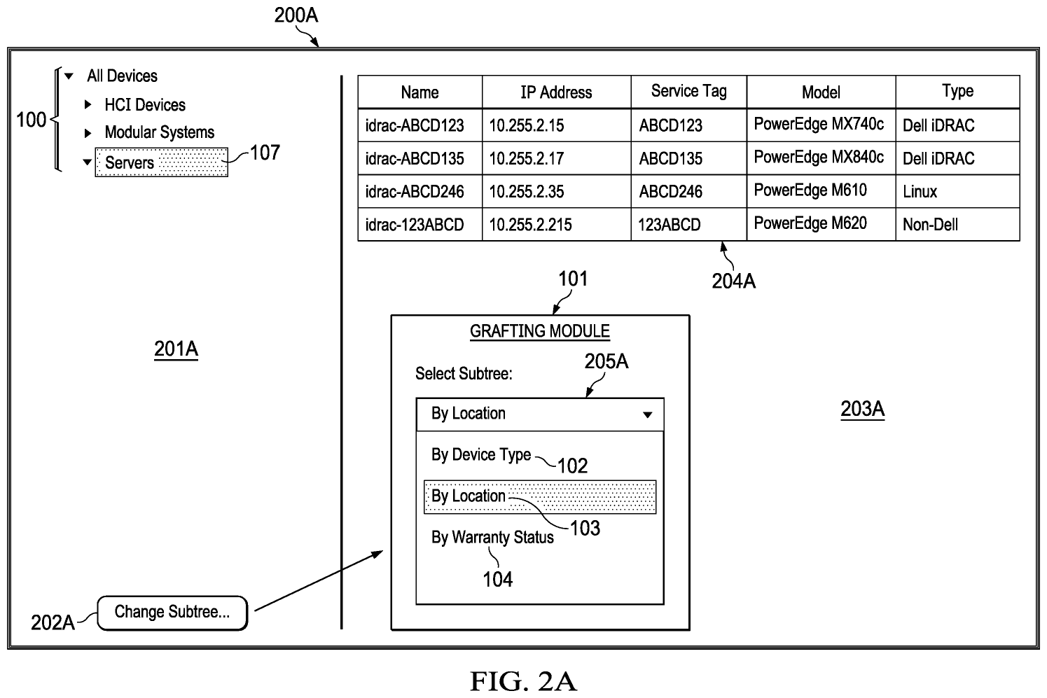

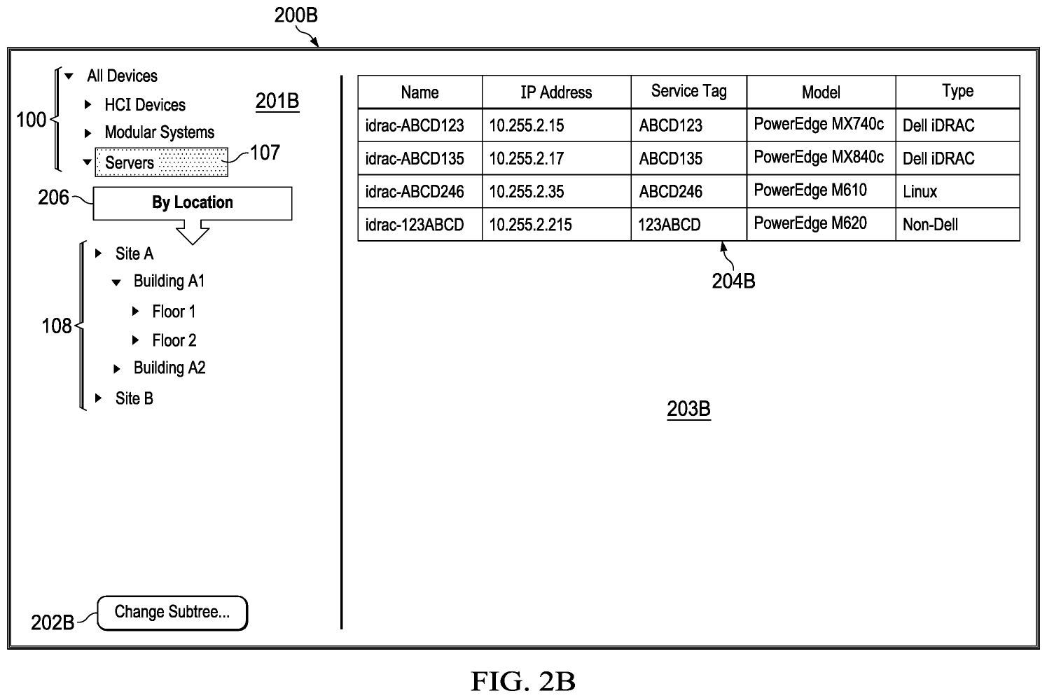

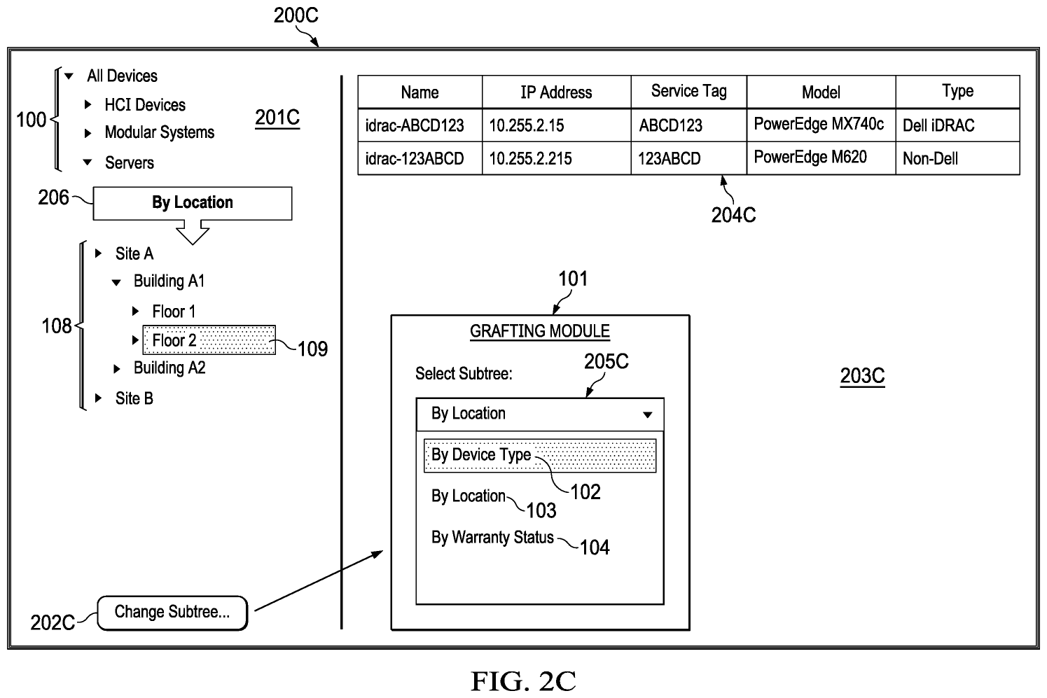

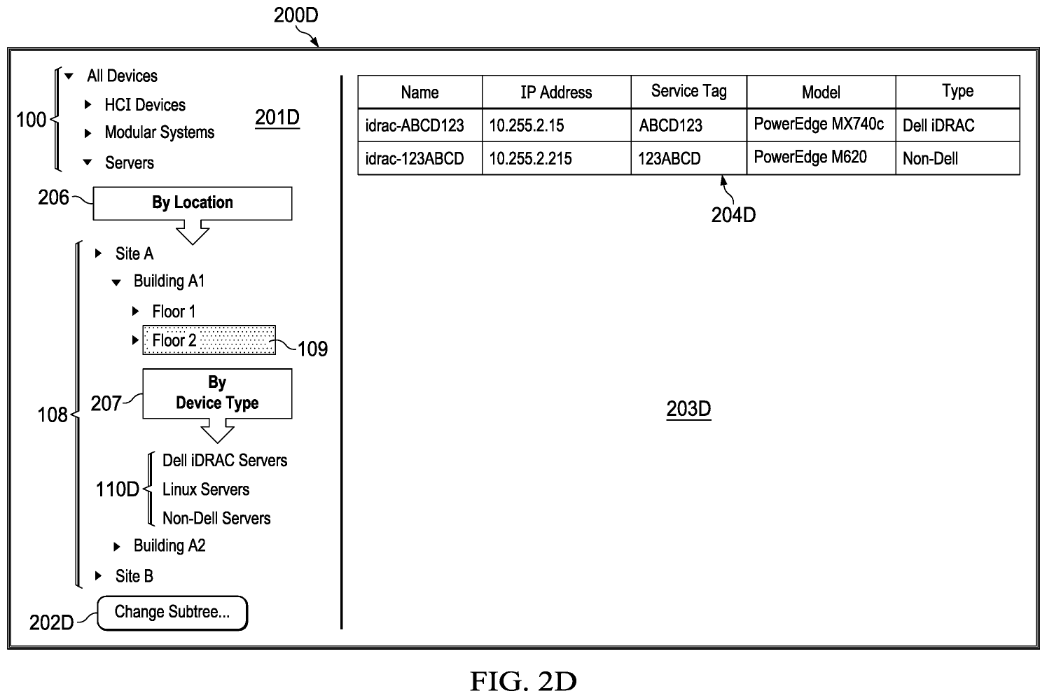

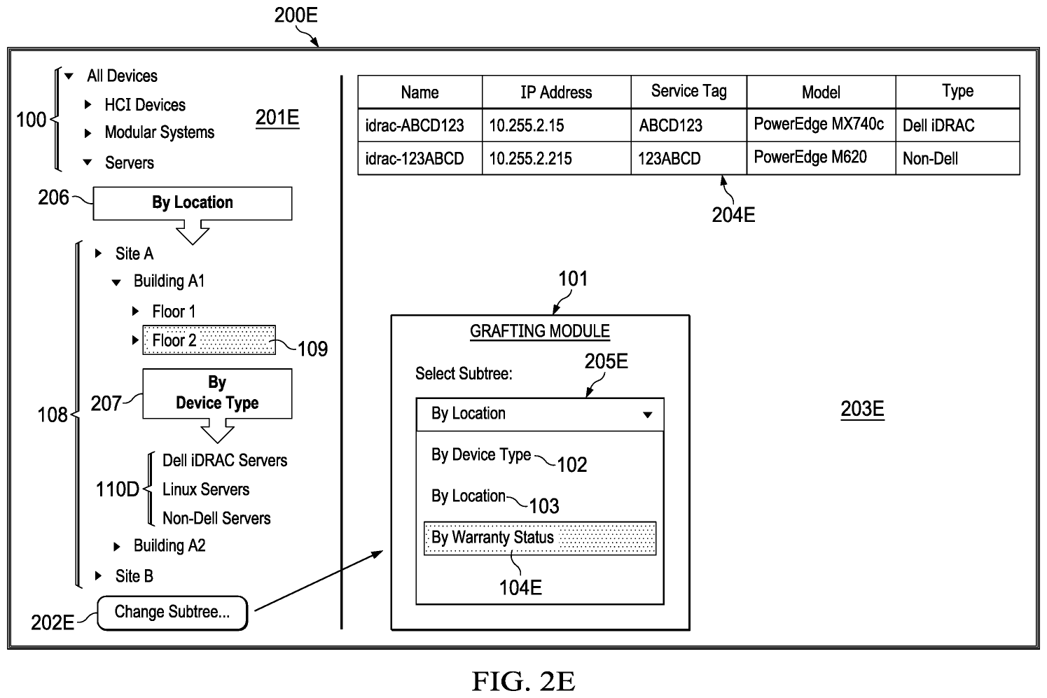

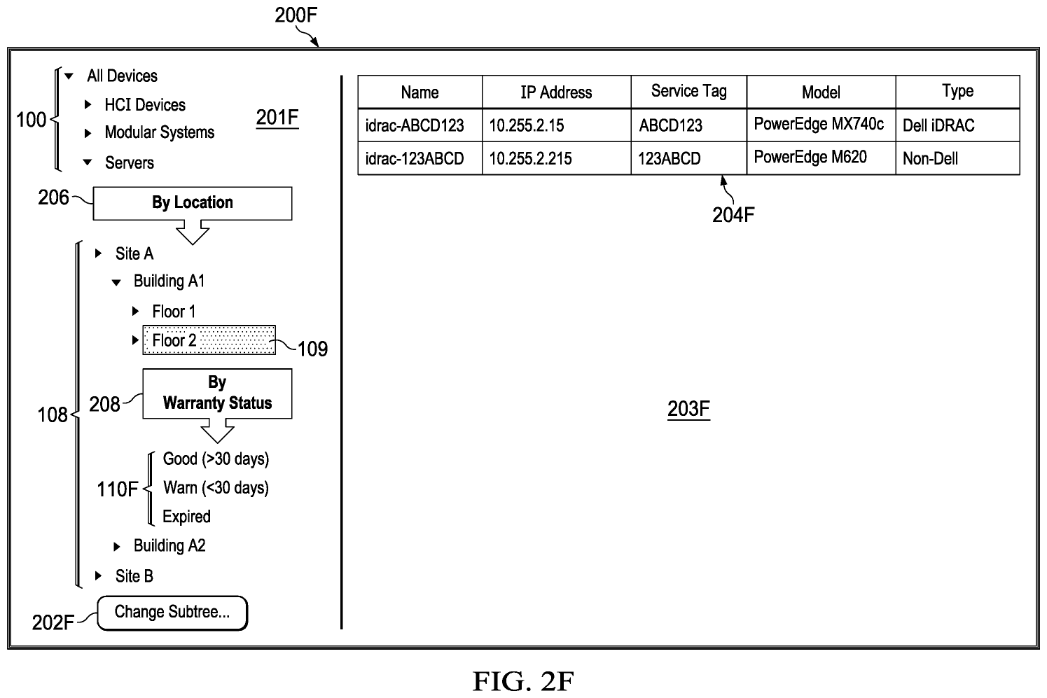

FIGS. 2A-F illustrate examples of methods for grafting hierarchical trees in a GUI. Specifically, web browser or client application GUI 200A of FIG. 2A includes navigation portion 201A, grafting control or button 202A (“Change subtree”), and table portion 203A. In this example, navigation portion 201A displays tree 100 with “All Devices” (“HCI Devices,” “Modular Systems,” and “Servers”). It should be noted that GUI 200A shows only one of many possible different interfaces that can support tree grafting.

Each node (“HCI Devices,” “Modular Systems,” and “Servers”) of tree 100 queries data items with corresponding keyword(s) and/or associated set of parameters. For example, a user may select node 107 (“Servers”) with the click of a mouse to perform a “server” query against all objects or data items otherwise stored in a database or the like. Results from the “server” query are shown as data items 204A of table portion 203A (All Devices-Servers).

In this example, because node 107 (“Servers”) is currently selected, table region 204A lists all servers in the database, regardless of their location or any other object property or parameters. Based on a page size of 25 rows, for example, the table could have hundreds of display pages. At this point, no grafting is in effect on servers node 107.

To graft a new sub-tree at node 107 (“Servers”), the user selects control 202A (“Change subtree”) which accesses grafting module 101 via active control or pop-up menu 205A, or the like. Once the user selects one of the sub-trees 102-104 (“By Device Type,” “By Location,” and “By Warranty Status”) listed in menu 205A, a new instance 108 of sub-tree 103 (“By Location”) is added to selected node 107.

In FIG. 2B, web browser or client application GUI 200B displays grafting point 206 and sub-tree 108 in navigation portion 201B, which has been added to hierarchical tree 100. As grafting point 206 indicates, each node of sub-tree 108 now queries current data items 204B in table portion 203B of GUI 200B by physical device location (“Site A,” “Site B,” etc.). In table portion 203B, because a node of sub-tree 108 is not yet selected, data items 204B are the same as data items 204A (All Devices-Servers-{By Location}). Sub-tree 108 itself includes two or more nested levels or nodes (e.g., “Floor 1” and “Floor 2” in “Building A1,” and “Building A1” and “Building A2” in “Site A”).

In GUI 200C of FIG. 2C, to graft a new sub-tree at node 109 (“Floor 2”), the user first highlights that node, which performs a corresponding query (“Floor 2” devices) reflected in updated data items 204C of table portion 203C. The user then clicks on control 202C (“Change subtree”) and selects another one of the sub-trees 102-104 (“By Device Type,” “By Location,” and “By Warranty Status”) listed in menu 205C (such that table portion 203D shows All Devices-Servers-{By Location}-Site A-Building A1-Floor 2).

Because the “Devices by Location” sub-tree was grafted onto the “Servers” node of the original tree 100, table portion 203C now shows only servers on Floor 2 of Building A1 of Site A. The number of objects or rows in table portion 203C is fewer than in 203B, and the user was able to dynamically drill down to the information wanted.

As grafting point 207 illustrates in GUI 200D of FIG. 2D, new instance 110D of sub-tree 102 (“By Device Type”) may be added to selected node 109. In table portion 203D, because a node of sub-tree 110D is not yet selected, data items 204D are the same as data items 204C (All Devices-Servers-{By Location}-Site A-Building A1-Floor 2-{By Device Type}) (indicating that a Device Type query has not yet been performed upon Floor 2 location).

In FIG. 2D, the user wants to see a breakdown of different types of servers, but only those on Floor 2 in Building A1 in Site A. This may be accomplished by grafting a sub-tree onto the Floor 2 node of the “Devices by Location” tree (which was grafted onto the Servers node of the “Devices by Type” tree). In this case, the original tree is grafted onto the current tree graft. Because the original graft was onto the Servers node 107, grafting back into the original tree maintains the constraint to include only servers. Nodes under “Floor 2” 109 show the nodes under Server in the “Devices by Type” tree, instead of location-oriented nodes. The user can then list only servers of a selected type on Floor 2 of Building A1 of Site A.

In GUI 200E of FIG. 2E, to replace sub-tree 110D at selected node 109, the user maintains node 109 highlighted, selects control 202E (“Change subtree”) and selects another one of the sub-trees 102-104 (“By Device Type,” “By Location,” and “By Warranty Status”) listed in menu 205E rendered by grafting module 101. In table portion 203E, because a node of sub-tree 112E is not yet selected, data items 204F are the same as data items 204E.

As grafting point 208 illustrates in GUI 200F of FIG. 2F, new instance 110F of sub-tree 104 (“By Warranty Status”) replaces sub-tree 110D. In table portion 203F, because a node of sub-tree 112F is not yet selected, data items 204F are the same as data items 204E (All Devices-Servers-{By Location}-Site A-Building A1-Floor 2-{By Warranty Status}).

In FIG. 2F, the user has changed the graft for the “Floor 2” node to the “Devices by Warranty Status” tree (another tree defined elsewhere in the application), by changing the selection in the “Change subtree” control. Now the nodes under the “Floor 2” node are the nodes of the “Devices by Warranty Status” tree. The user can select any node to list the devices applicable to a warranty status. As such, users can drill down into device data however they want, not being constrained by the original tree or hard-coded structure and with unlimited possibilities.

As noted above, systems and methods described herein may employ hierarchical trees to enable users to visually navigate data items stored in any database. Moreover, in the particular example of FIGS. 2A-F, data items related to other IHSs distributed located and connected to a network, such that each IHS has a respective IP address. Each of data items in in table portions 203A-F includes an IHS name, an IP address, a service tag, a model name or number, and a device type. In this case, selecting a particular data item may trigger a request to establish a shared desktop session with the selected IHS over a network, with video, keyboard, and/or mouse (KVM) redirection between the GUI's user and a remote IHS.

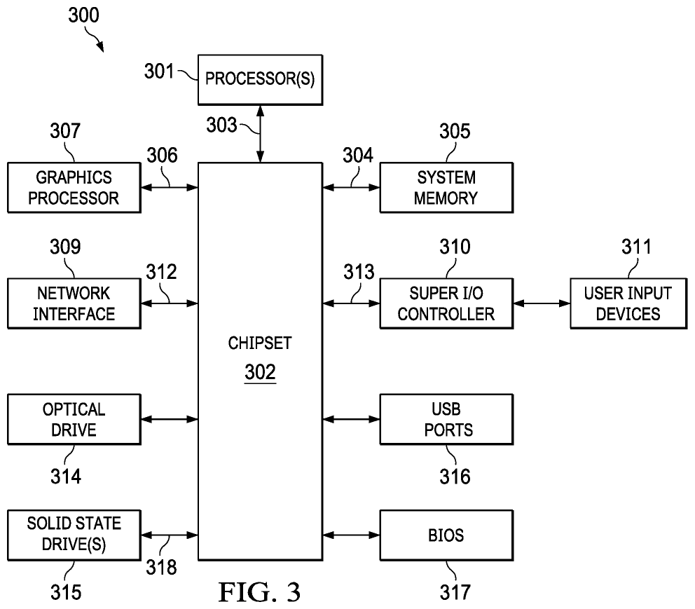

FIG. 3 is a block diagram of IHS 300. In various embodiments, IHS 300 may be configured to implement systems and methods for grafting hierarchical trees in a GUI as described in connection with FIG. 1 and FIGS. 2A-F. For example, IHS 300 may be configured to execute any operating system with a window-based GUI. In some cases, a GUI may be built using any suitable programming language, toolkit, or Application Programming Interface (API).

As shown, IHS 300 may include one or more processors 301. In various implementations, IHS 300 may be a single-processor system including one processor 301, or a multi-processor system including two or more processors 301. Processor(s) 301 may include any processor capable of executing program instructions, such as an Intel Pentium™ series processor or any general-purpose or embedded processors having any of a variety of Instruction Set Architectures (ISAs), such as the x86, POWERPC®, ARM®, SPARC®, or MIPS® ISAs, or any other suitable ISA.

IHS 300 includes chipset 302 that may include one or more integrated circuits that are connect to processor(s) 301. In certain embodiments, chipset 302 may utilize QuickPath Interconnect (QPI) bus 303 for communicating with the processor(s) 301. Chipset 302 provides the processor(s) 301 with access to a variety of resources. For instance, chipset 302 provides access to system memory 305 over memory bus 304. System memory 305 may be configured to store program instructions and/or data accessible by processors(s) 301. In various embodiments, system memory 305 may be implemented using any suitable memory technology, such as static RAM (SRAM), dynamic RAM (DRAM) or nonvolatile/Flash-type memory.

Chipset 302 may also provide access to graphics processor 307. In certain embodiments, graphics processor 307 may be comprised within one or more video or graphics cards that have been installed as components of IHS 300. Graphics processor 307 may be coupled to chipset 302 via graphics bus 306 such as provided by an Accelerated Graphics Port (AGP) bus or a Peripheral Component Interconnect Express (PCIe) bus. In certain embodiments, graphics processor 307 generates display signals and provides them to HMD device 102 via video interface 209.

In certain embodiments, chipset 302 may also provide access to one or more user input devices 311. In such embodiments, chipset 302 may be coupled to a super I/O controller 310 that provides interfaces for a variety of user input devices 311, in particular lower bandwidth and low data rate devices. For instance, super I/O controller 310 may provide access to a keyboard and mouse or other peripheral input devices. In certain embodiments, super I/O controller 310 may be used to interface with coupled user input devices 311 such as keypads, biometric scanning devices, and voice or optical recognition devices, through wired or wireless connections. In certain embodiments, chipset 302 may be coupled to the super I/O controller 310 via a Low Pin-Count (LPC) bus 313.

Other resources may also be coupled to the processor(s) 301 of IHS 300 through chipset 302. In certain embodiments, chipset 302 may be coupled to a network interface 309, such as provided by a Network Interface Controller (NIC) that is coupled to IHS 300. In certain embodiments, the network interface 309 may be coupled to chipset 302 via a PCIe bus 312. According to various embodiments, network interface 309 may support communication via various wired and/or wireless networks. In certain embodiments, chipset 302 may also provide access to one or more Universal Serial Bus (USB) ports 316; which in some implementations may serve as transport for establishing control interface 208 with HMD 102.

Chipset 302 also provides access to one or more solid-state storage devices 315. Chipset 302 utilizes a PCIe bus interface connection 318 in order to communication with the solid-state storage device 315. In certain embodiments, chipset 302 may also provide access to other types of storage devices. For instance, in addition to the solid-state storage device 315, an IHS 300 may also utilize one or more magnetic disk storage devices, or other types of the storage devices such as an optical drive or a removable-media drive. In various embodiments, the solid-state storage device 315 may be integral to IHS 300, or may be located remotely from IHS 300.

Another resource that may be accessed by processor(s) 301 via chipset 302 is a Basic Input/Output System (BIOS) 317. As described in more detail below with respect to additional embodiments, upon powering or restarting IHS 300, processor(s) 301 may utilize BIOS 317 instructions to initialize and test hardware components coupled to IHS 300 and to load an operating system for use by IHS 300. BIOS 317 provides an abstraction layer that allows the operating system to interface with certain hardware components that are utilized by IHS 300. Via this hardware abstraction layer provided by BIOS 317, the software executed by the processor(s) 301 of IHS 300 is able to interface with certain I/O devices that are coupled to IHS 300. As used herein, the term “BIOS” is intended to also encompass Unified Extensible Firmware Interface (UEFI).

In various embodiments, IHS 300 may not include each of the components shown in FIG. 3. Additionally, or alternatively, IHS 300 may include various components in addition to those that are shown in FIG. 3. Furthermore, some components that are represented as separate components in FIG. 3 may, in some embodiments, be integrated with other components. For example, in various implementations, all or a portion of the functionality provided by the illustrated components may instead be provided by components integrated into the one or more processor(s) as a system-on-a-chip (SOC) or the like.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor; and
a memory coupled to the processor, the memory having program instructions stored thereon that, upon execution by the processor, cause the IHS to:
receive, from a user, selection of a first node of a hierarchical tree displayed via a Graphical User Interface (GUI), wherein the first node enables the user to navigate data items with a first query;
receive, from the user, selection of a first sub-tree; and
graft the first sub-tree onto the first node, wherein the first grafted sub-tree enables the user to navigate a first subset of data items with a second query, and wherein the first subset of data items results from application of the first query to the data items.

2. The IHS of claim 1, wherein the hierarchical tree is displayed via a web browser or client application in a navigation portion of the GUI.

3. The IHS of claim 2, wherein the data items are displayed via the web browser or client application in a table portion of the GUI.

4. The IHS of claim 3, wherein the program instructions, upon execution by the processor, further cause the IHS to filter or order the data items in the table portion of the GUI differently in response to selection of a different node of the hierarchical tree in the navigation portion of the GUI.

5. The IHS of claim 4, wherein the program instructions, upon execution by the processor, further cause the IHS to filter or order the first subset of data items in the table portion of the GUI differently in response to selection of a different node of the grafted sub-tree in the navigation portion of the GUI.

6. The IHS of claim 1, wherein the program instructions, upon execution by the processor, further cause the IHS to display a grafting tool menu via the GUI, and wherein the grafting tool menu enables the user to select the first sub-tree among a plurality of sub-trees.

7. The IHS of claim 6, wherein at least one of the plurality of subtrees comprises two or more different hierarchical levels.

8. The IHS of claim 6, wherein at least one of the plurality of subtrees enables the first subset of data items to be sorted by physical location of physical devices corresponding to the data items.

9. The IHS of claim 6, wherein at least one of the plurality of subtrees sorts the first subset of data items by type of physical device corresponding to the data items.

10. The IHS of claim 6, wherein at least one of the plurality of subtrees sorts the first subset of data items by warranty status corresponding to the data items.

11. The IHS of claim 1, wherein the program instructions, upon execution by the processor, further cause the IHS to:
receive, from the user, selection of a second node of the first grafted sub-tree;
receive, from the user, selection of a second sub-tree; and
graft the second sub-tree onto the second node of the first grafted subtree, wherein the second grafted sub-tree enables the user to navigate a second subset of data items with a third query, and wherein the second subset of data items results from application of the second query to the first subset of data items.

12. The IHS of claim 11, wherein the program instructions, upon execution by the processor, further cause the IHS to
receive, from the user, selection of the second node of the first grafted sub-tree;
receive, from the user, selection of a third sub-tree; and
replace the second grafted sub-tree with the third sub-tree, wherein the third sub-tree enables the user to navigate the second subset of data items with a fourth query.

13. A method, comprising:
receiving, from a user, selection of a first node of a hierarchical tree displayed by an Information Handling System (IHS) via a Graphical User Interface (GUI), wherein the first node enables the user to navigate data items;
receiving, from the user, selection of a first sub-tree; and
grafting the first sub-tree onto the first node, wherein the first grafted sub-tree enables the user to navigate a first subset of data items with a second query, and wherein the first subset of data items results from application of a first query to the data items.

14. The method of claim 13, wherein the hierarchical tree is displayed via a web browser or client application executed by the IHS in a navigation portion of the GUI, and wherein the data items are displayed via the web browser or client application executed by the IHS in a table portion of the GUI.

15. The method of claim 14, further comprising filtering or ordering the data items in the table portion of the GUI differently in response to selection of a different node of the hierarchical tree or the grafted sub-tree in the navigation portion of the GUI.

16. The method of claim 13, further comprising displaying a grafting tool menu via the GUI, wherein the grafting tool menu enables the user to select the first sub-tree among a plurality of sub-trees.

17. The method of claim 13, wherein at least one of the plurality of subtrees enables the first subset of data items to be sorted by physical location, type of physical device, or warranty status of a physical device corresponding to the data item.

18. The method of claim 13, further comprising:
receiving, from the user, selection of a second node of the first grafted sub-tree;
receiving, from the user, selection of a second sub-tree; and
grafting the second sub-tree onto the second node of the first grafted subtree, wherein the second grafted sub-tree enables the user to navigate a second subset of data items with a third query, and wherein the second subset of data items results from application of the second query to the first subset of data items.

19. A hardware memory of an Information Handling System (IHS), the hardware memory having program instructions stored thereon that, upon execution by a processor, cause the IHS to:
receive, from a user, selection of a first node of a hierarchical tree displayed by the IHS via a Graphical User Interface (GUI), wherein the first node enables the user to navigate data with a first query;
receive, from the user, selection of a first sub-tree;
graft the first sub-tree onto the first node, wherein the first grafted sub-tree enables the user to navigate a first subset of data items, and the first subset of data items results from application of the first query to the data items;
receive, from the user, selection of a second node of the first sub-tree;
receive, from the user, selection of a second sub-tree; and
graft the second sub-tree onto the second node, wherein the second grafted sub-tree enables the user to navigate the first subset of data items.

20. The hardware memory of claim 19, wherein the program instructions upon execution by a processor, cause the IHS to:
receive, from the user, selection of the first node of the hierarchical tree;
receive, from the user, selection of a third sub-tree; and
replace the first grafted sub-tree with the third sub-tree, wherein the third sub-tree enables the user to navigate the data items with a third query.
